(19) United States
(12) Patent Application Publication
(10) Pub. No.: US 2004/0118591 A1
(43) Pub. Date: Jun. 24, 2004

(54) Transmission line for radio frequency communications

(75) Inventors: Dan Bufanda, Burlington, CT (US); Heinz Rothmann, Westbrook, CT (US); Darin Bookey SR., Meriden, CT (US)

Correspondence Address: SUGHRUE MION, PLLC, 2100 PENNSYLVANIA AVENUE, N.W., SUITE 800, WASHINGTON, DC, 20037, US

(73) Assignee: RADIO FREQUENCY SYSTEMS, INC.

(21) Appl. No.: 10/324,036

(22) Filed: Dec. 20, 2002

(51) Int. Cl. H01B 7/18; H01B 9/02

(52) U.S. Cl. 174/106 R

(57) ABSTRACT

An improved transmission line for RF communications. A transmission line comprising a center conductor; a dielectric layer surrounding the center conductor; a bimetallic outer conductor including an outer conductive layer and an inner conductive layer; wherein the outer conductive layer and the inner conductive layer are of differing materials; and the inner conductive layer is copper or copper alloy; and an insulating jacket surrounding the bimetallic outer conductor. Other aspects do not require the center conductor or the dielectric layer. Further aspects include a bimetallic center conductor. Advantages of the transmission line include imperviousness to signal loss due to surface abnormalities (due to inner conductive layer being interior to and encapsulated by outer conductive layer); the potential for significant cost savings in material; excellent RF communications signal propagation; and a significant reduction in weight.

### FIELD OF THE INVENTION

This invention relates to a transmission line for radio frequency communications.

### BACKGROUND OF THE INVENTION

FIG. 1 shows a conventional coaxial cable that comprises a center copper conductor 10 surrounded longitudinally by a dielectric material 12; the dielectric material 12 longitudinally surrounded by a braided shield/outer conductor 14; and the braided shield/outer conductor 14 longitudinally surrounded by an insulating jacket 16. In many instances, the outer conductor 14 is also made of solid copper sheath, the sheath being corrugated for flexibility. While the conventional coaxial cable allows for transmission of communications signals, the cable has several disadvantages.

For example, while the copper conductors possess generally favorable anticorrosion characteristics and generally favorable radio frequency (hereinafter “RF”) communications transmission qualities, the use of a conductor entirely made of copper is costly.

While other metals, such as aluminum, have been used in place of copper, such metals generally do not possess the low loss properties required for as high a quality of RF signal propagation as does copper.

Furthermore, due to the phenomenon known as the “skin effect,” high-frequency RF communication signals travel almost entirely along the surface of the center and outer conductors 10 and 14. Because of the “skin effect,” any anomaly or abnormality in the surface of conductors 10 or 14 degrades RF communications signal propagation. Such anomalies or abnormalities include corrosion, pitting, gouges, nicks, scratches and the like. The presence of such anomalies or abnormalities varies in result from simple signal degradation all the way to unacceptable system performance.

### SUMMARY OF THE INVENTION

Illustrative, non-limiting embodiments of the present invention overcome the disadvantages described above and other disadvantages.

In an illustrative, non-limiting implementation of the present invention, a transmission line for RF communications is provided. The transmission line comprises a center conductor, an outer conductor, and a dielectric disposed between the center and outer conductors. The outer conductor is a bimetallic conductor comprising an outer conductive layer and an inner conductive layer, wherein the outer conductive layer and the inner conductive layer are of differing materials and the inner conductive layer is copper or copper alloy. An insulating jacket surrounds the outer conductor. According to another aspect of the invention, a waveguide transmission line is provided which includes a copper inner layer and a reinforcing metallic outer layer of a material different from copper, such as aluminum.

### BRIEF DESCRIPTION OF THE DRAWINGS

The invention, both as to its organization and manner of operation, may be further understood by reference to the drawings (not drawn to scale) that include FIGS. 1-6 taken in connection with the following description.

FIG. 1 is a cross-sectional view of a conventional coaxial cable;

FIG. 2 is a cross-sectional view of a transmission line according to a first embodiment of the invention;

FIG. 3 is a cross-sectional view showing the bimetallic strip that constitutes the outer conductor;

FIG. 4 is a cross-sectional view showing another example of the bimetallic strip that constitutes the outer conductor;

FIG. 5 is a cross-sectional view of a transmission line according to a second embodiment of the invention;

FIG. 6 is a cross-sectional view of a waveguide transmission line according to still a further embodiment of the invention.

### DESCRIPTION OF ILLUSTRATIVE NON-LIMITING EMBODIMENTS OF THE INVENTION

The following description of illustrative non-limiting embodiments of the invention discloses specific configurations and components. However, the embodiments are merely examples of the present invention, and thus, the specific features described below are merely used to more easily describe such embodiments and to provide an overall understanding of the present invention. Accordingly, one skilled in the art will readily recognize that the present invention is not limited to the specific embodiments described below. Furthermore, the descriptions of various configurations and components of the present invention that are known to one skilled in the art are omitted for the sake of clarity and brevity.

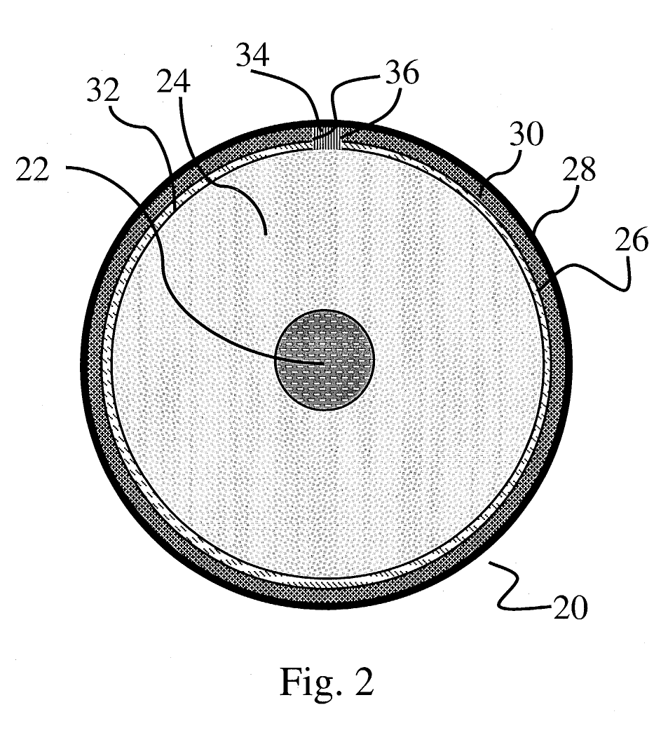

FIG. 2 is a cross-sectional view of an improved transmission line 20 for RF communications in accordance with an illustrative, non-limiting embodiment of the present invention. As shown in the figure, transmission line 20 comprises a center conductor 22; a bimetallic outer conductor 26; a dielectric layer 24 interposed between the center conductor 22 and the bimetallic outer conductor 26; and an insulating jacket 28 which circumscribes the outer conductor 26. According to the invention, the outer conductor 26 is bimetallic, including an outer conductive layer 30 and an inner conductive layer 32. The inner conductive layer 32 is made of copper or copper alloy, while the outer conductive layer 30 may preferably be made of a less expensive metal such as stainless steel, brass or aluminum.

The outer conductive layer 30 provides structural support and shielding to prevent RF leakage beyond the inner conductive layer 32, while the inner conductive layer 32 provides a low loss conductive path for RF transmissions. The inner copper conductor thickness is determined by loss performance required for the frequency application and not mechanical properties. The thickness of the copper may be less than one-thousandth of an inch.

In a further preferred embodiment, the transmission line 20 is corrugated for flexibility.

According to the preferred embodiment illustrated in FIG. 2, the inner conductive layer 32 does not completely circumscribe the dielectric layer 24, leaving a gap 34 filled by the lateral edges 36 of outer conductive layer 30. This reflects a simple method of construction in that it is easier to make one butt-welded seam of the outer conductive layer 30 than it is to make two butt-welded seams (one for the outer conductive layer 30 and another for the inner conductive layer 32).

Additionally, in other non-limiting aspects of the invention, where the opposing lateral edges 36 of the outer conductive layer 30 are butt-welded to each other, extreme heat is inherent during the welding process. Since outer conductive layer 30 and inner conductive layer 32 are made of different materials, they possess different melting points and welding temperatures. As such, in certain non-limiting aspects of the present invention, it is preferable that the inner conductor layer 32 not extend into the butt-welding seam zone 34 of the outer conductive layer 30, especially when using an outer conductive layer 30 which has a higher melting point than the melting point of the inner conductive layer 32. As inner conductive layer 32 comprises copper or a copper alloy, copper possessing a melting point of 1084 degrees Celsius, it is preferable to maintain the gap 34 if, for instance, steel is used as the outer conductive layer 30, as steel possesses a melting point of 1500 degrees Celsius. Of course, it should be understood that the invention is not limited in this respect—i.e., the inner conductive layer 32 could extend around the entire circumference of the dielectric layer without forming the gap 34. Further, the invention is not limited to welding the outer conductive layer 30.

The dielectric layer 24 may be a foam dielectric, a helically wound dielectric or any other well-known type of dielectric. Similarly, the insulating jacket 28 is made of well-known materials such as polyethylene or fire retardant materials. Such insulating jacket materials are well-known in the art. Furthermore, the process of sheathing a conductor with an insulating jacket is well known in the art, and may or may not include the use of an adhesive to bond the insulating jacket 28 to the outer conductive layer 30. A bonding process using an adhesive is disclosed in U.S. Pat. Nos. 3,272,912; 3,618,515; and 4,107,354. The use of ethylene acrylic acid adhesives in this manner is widely practiced in the art.

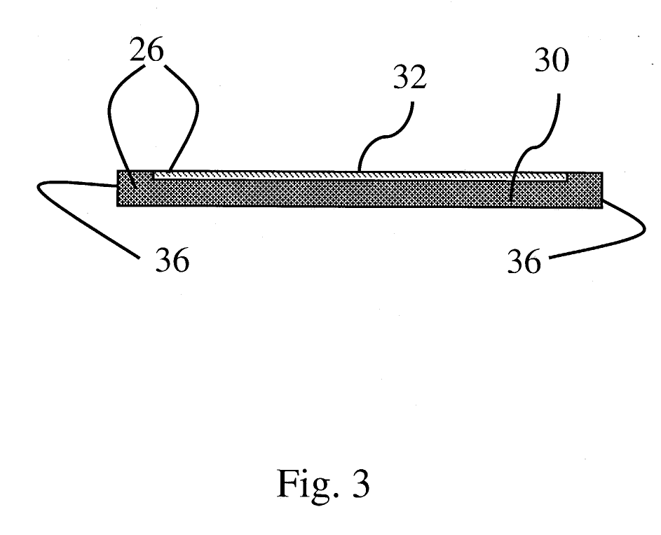

There are two preferred methods of forming the bimetallic outer conductor 26. In the first method shown in FIG. 3, the inner layer 32 is inlaid in the outer layer 30. This allows for the lateral edges 36 of the outer conductive layer 30 to be welded to each other in the simple manner as discussed above. Further, as discussed above, this allows for the lateral edges 36 of the outer conductive layer 30 to be welded to each other without adversely effecting the inner layer 32.

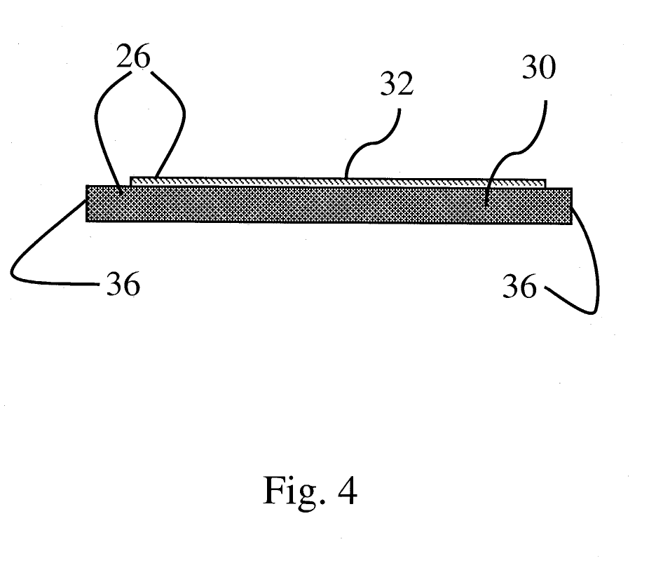

In the alternative method shown in FIG. 4, the bimetallic outer conductor 26 is formed by bonding the inner conductive layer 32 to the outer conductive layer 30, where the width of the inner conductive layer 32 is less than the width of the outer conductive layer 32. In another non-limiting aspect of the present invention, the inner conductive layer 32 may be of equal width to outer conductive layer 30. In either the method shown in FIG. 3 or the method shown in FIG. 4, the strips are wrapped in a circumference with inner conductive layer 32 interior to outer conductive layer 30 and the edges 36 of outer conductive layer 30 are butt-welded so that the adjoining edges 36 of the outer conductive layer 30 come together to make one circumference with a seam along the butt-weld axis.

It should be noted that modification can be made to the preferred embodiment of the invention, without departing from the spirit of the invention. For example, the invention is not limited to the previously disclosed transmission line which can be used as coaxial cable.

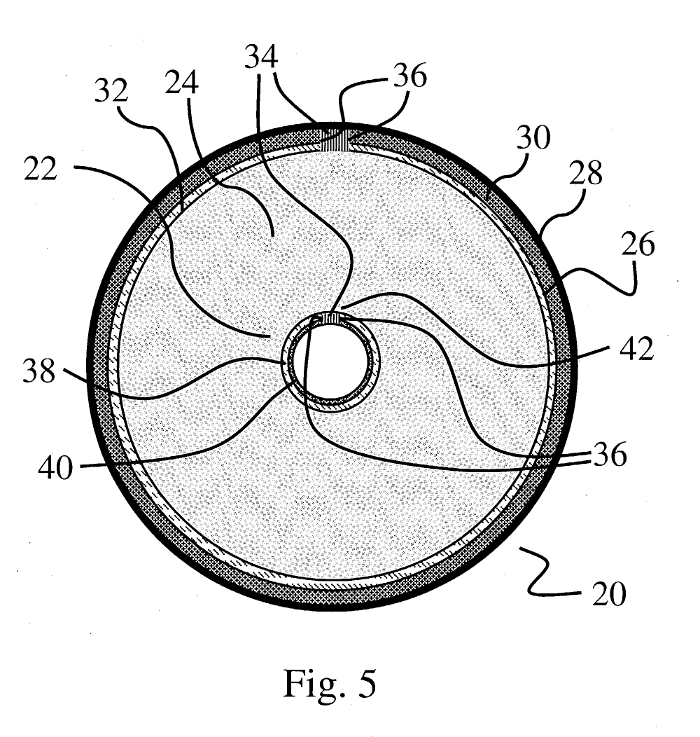

With reference to FIG. 5, according to another embodiment of the invention, the center conductor 22 may be a hollow tube or a solid wire. Center conductor 22 may further be of either of monometallic construction or may be bimetallic in nature, with a center outer conductive layer 38 made of copper or copper alloy and a center interior conductive layer 40 made of a differing material than center outer conductor 38. The center interior conductive layer 40 may comprise aluminum or steel, so long as the structure of center interior conductive layer 40 is such so as to support the center outer conductive layer 38. Center outer conductive layer 38 may be less than one-thousandth of an inch in thickness, or only that amount of copper as desired for loss performance. Along these lines, if the center conductor 22 is hollow, it can be formed in the same manner discussed above with respect to the bimetallic outer conductor 26. In this case, the circumference of the outer conductive copper layer 38 would be smaller than the circumference of the interior conductive layer 40 such that a gap 42 is provided between the opposite lateral edges 36 of the copper layer 38. Also, the gap 42 would be aligned with the butt-weld seam zone 34.

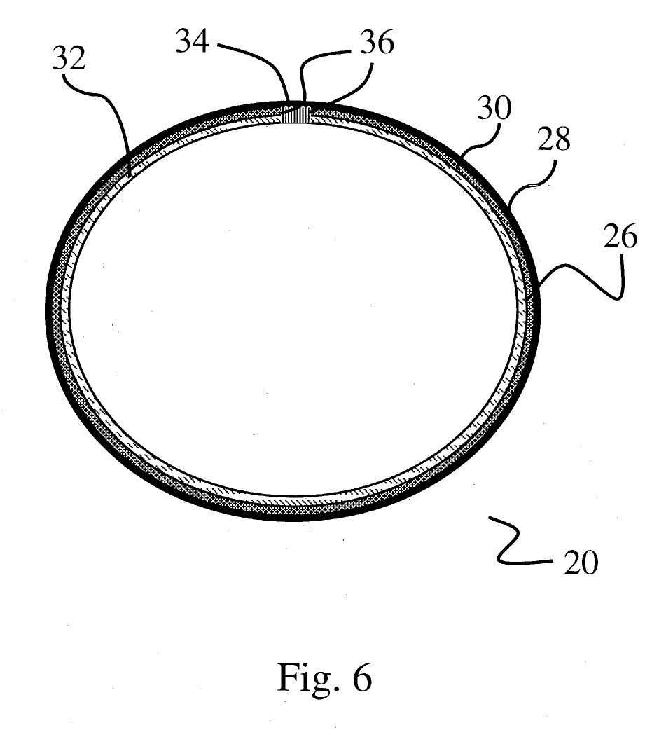

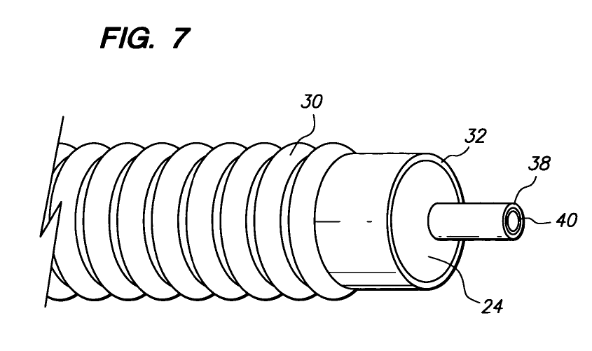

Additionally, in another non-limiting aspect of the present invention as shown in FIG. 6, the dielectric 24 can be eliminated, the resulting conductor thus constituting a waveguide transmission line including the bimetallic conductor 26 with or without insulating jacket 28. In a preferred embodiment, the waveguide transmission line is elliptical in shape, but the invention is not limited to such and may be more oval or circular in nature than elliptical. Furthermore, butt-weld seam zone 34 is not limited to any particular periphery along the curve of the ellipse and may be located at any location along the circumference.

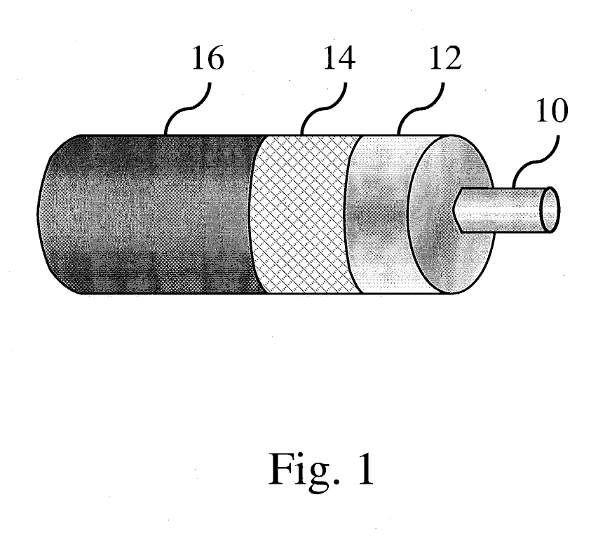

The above embodiments clearly have various advantages over the conventional coaxial cable shown in FIG. 1. Advantageous characteristics in non-limiting embodiments of the present invention include: imperviousness to signal loss due to surface abnormalities (due to inner conductive layer 32 being interior to and encapsulated by outer conductive layer 30); potential cost savings in material; excellent RF communications signal propagation; and a reduction in weight. These items will be discussed in turn.

To begin with, inner conductive layer 32 is protected from corrosion by being longitudinally encapsulated by outer conductive layer 30. This encapsulation ensures that moisture and other contaminants remain exterior to inner conductive layer 32, preventing pitting, corrosion, or other abnormalities from occurring to the copper. This, in turn, ensures that inner conductive layer 32 maintains peak propagation of the communications signal(s), wherein these signal(s) may include high frequency RF communications signal(s).

In addition, since the amount of copper can be reduced to only that amount necessary for peak propagation of the RF communications signal (the copper being reduced to as thin as less than one-thousandth of an inch), the possibility of significant material cost savings can be realized, as is readily apparent when comparing the weight and density of copper to aluminum and their relative cost.

A further advantageous characteristic of a non-limiting embodiment of the present invention includes excellent RF communications signal propagation. In comparison, where aluminum has been used as a communications conductor, the result is an increase in signal line loss, and, therefore, a reduction in the level of quality of RF signal propagation as compared to copper.

A further readily apparent advantageous characteristic of a non-limiting embodiment of the present invention is retention of copper's excellent RF communications signal propagation characteristics while simultaneously providing a reduction in weight. This reduction in weight shrinks shipping costs and reduces the manpower necessary for installation of the transmission line.

The previous description of the preferred embodiments is provided to enable a person skilled in the art to make and use the present invention. Moreover, various modifications to these embodiments will be readily apparent to those skilled in the art, and the generic principles and specific examples defined herein may be applied to other embodiments without the use of inventive faculty. For example, some or all of the features of the different embodiments discussed above may be deleted from the embodiment. Therefore, the present invention is not intended to be limited to the embodiments described herein but is to be accorded the widest scope as defined by the limitations of the claims and equivalents thereof.

What is claimed is:

1. A transmission line comprising:
a center conductor;
a dielectric layer surrounding said center conductor;
a bimetallic outer conductor including an outer conductive layer and an inner conductive layer; and
an insulating jacket surrounding said bimetallic outer conductor, wherein the outer conductive layer and the inner conductive layer are of differing materials and the inner conductive layer is copper or copper alloy.

2. The transmission line of claim 1, wherein the outer conductive layer comprises one of aluminum or steel.

3. The transmission line of claim 2, wherein the outer conductive layer is an impermeable, solid-walled tube.

4. The transmission line of claim 1, wherein:
the insulating jacket comprises one of polyethylene and a fire-retardant material.

5. The transmission line of claim 1, wherein the center conductor includes one of a solid wire or hollow tube.

6. The transmission line of claim 5, wherein the center conductor is bimetallic including a center outer conductive layer and a center inner conductive layer.

7. The transmission line of claim 6, wherein the center outer conductive layer and the center inner conductive layer are of differing materials and the center outer conductive layer is copper or copper alloy.

8. The transmission line of claim 6, wherein the center inner conductive layer is an impermeable, solid-walled tube.

9. The transmission line of claim 7, wherein the center inner conductive layer comprises one of aluminum or steel.

10. The transmission line of claim 1, wherein said inner conductive layer of the bimetallic outer conductor is inlaid within said outer conductive layer of the bimetallic outer conductor.

11. The transmission line of claim 10, wherein said outer conductive layer includes a weld seam at which lateral opposite sides of said outer conductive layer are joined.

12. The transmission line of claim 11, wherein a gap is provided between opposite lateral sides of said inner conductive layer.

13. The transmission line of claim 1, wherein said inner conductive layer of the bimetallic outer conductor is bonded to said outer conductive layer of the bimetallic outer conductor.

14. The transmission line of claim 13, wherein said outer conductive layer includes a weld seam at which lateral opposite sides of said outer conductive layer are joined.

15. The transmission line of claim 14, wherein a gap is provided between opposite lateral sides of said inner conductive layer.

16. The transmission line of claim 1, wherein the bimetallic outer conductor is corrugated.

17. A waveguide transmission line, comprising:
a tubular conductor including an outer conductive layer and an inner conductive layer; wherein
the outer conductive layer is made of a different material from the inner conductive layer; and
further wherein said inner conductive layer comprises copper or copper alloy.

18. The waveguide transmission line of claim 17, wherein said outer conductive layer comprises one of aluminum or steel.

19. The waveguide transmission line of claim 18, wherein the outer conductive layer is an impermeable, solid-walled tube.

20. A transmission line comprising:
a center conductor;
a dielectric layer surrounding said center conductor;
an outer conductor surrounding said dielectric layer; and
an insulating jacket surrounding said outer conductor; wherein
the center conductor is bimetallic including a center outer conductive copper layer and a center inner conductive layer made of a different material than said center outer conductive copper layer; and wherein
said center outer conductive copper layer has a circumference which is smaller than a circumference of the center inner conductive layer and wherein opposite lateral edges of said center inner conductive layer are welded together to form a longitudinal weld seam.

21. The transmission line of claim 20, wherein a gap is provided between opposite lateral edges of said center outer conductive copper layer.

22. The transmission line of claim 21, wherein said gap is aligned with said weld seam.
